(19) United States
(12) Patent Application Publication
(10) Pub. No.: US 2026/0142410 A1
(43) Pub. Date: May 21, 2026

(54) CONNECTOR ASSEMBLY MACHINE FOR ELECTRICAL CONNECTOR INCLUDING GROMMETS

(71) Applicants: TE Connectivity Solutions GmbH, Schaffhausen (CH); Tyco Electronics (Shanghai) Co., Ltd., Shanghai (CN)

(72) Inventors: Angel Alberto Slistan, Middletown, PA (US); Sun Kyu Pak, Middletown, PA (US); Pablo Plascencia, Middletown, PA (US); Roberto Francisco-Yi Lu, Middletown, PA (US); Xianghao Bao, Shanghai (CN); Jian Cao, Shanghai (CN); Xinping Deng, Middletown, PA (US)

(21) Appl. No.: 19/013,261

(22) Filed: Jan. 8, 2025

(30) Foreign Application Priority Data
Nov. 20, 2024 (CN) 202411667853.0

(51) Int. Cl. H01R 13/52; H01R 13/66; H01R 43/20

(52) U.S. Cl. CPC H01R 13/5205; H01R 13/6683; H01R 43/20

(57) ABSTRACT

A connector assembly machine for an electrical connector that includes a grommet in a housing includes a feeder assembly having a feeder device for feeding a carrier, holding the housing and the grommet, to a grommet seating station. The connector assembly machine includes a grommet seating assembly at the grommet seating station with a grommet press. The grommet press includes a support wall, a ram movably coupled to the support wall, and an actuator operably coupled to the ram to move the ram between an upper position and a lower position. The ram includes a grommet press tool having a press surface configured to engage and press the grommet into the housing when the ram is moved from the upper position to the lower position to seat the grommet in the housing at a seated position.

### CROSS REFERENCE TO RELATED APPLICATIONS

This application claims benefit to Chinese Application No. 202411667853.0, filed 20-Nov.-2024, the subject matter of which is herein incorporated by reference in its entirety.

### BACKGROUND OF THE INVENTION

The subject matter herein relates generally to electrical connector assembly machines.

Electrical connectors are used in numerous applications, such as automotive applications, to electrically connect various components together. The electrical connector includes a housing holding contacts, which may be terminated to ends of wires. Some applications require a sealed interface. For example, the electrical connector may include a sealing grommet received in the housing to provide a sealed interface to the housing and the wires. Typically, assembly of the electrical connector is performed by hand. For example, the grommet may be hand loaded into the housing and the contacts may be hand loaded, through openings in the grommet, into the housing. Such hand assembly is time consuming and leads to inconsistent assembly.

A need remains for an electrical connector assembly machine for automating assembly steps for high speed, repeatable, and reliable assembly.

### BRIEF DESCRIPTION OF THE INVENTION

In one embodiment, a connector assembly machine for an electrical connector that includes a grommet in a housing is provided. The connector assembly machine includes a feeder assembly which includes a feeder device configured to feed a carrier holding the housing and the grommet to a grommet seating station. The connector assembly machine includes a grommet seating assembly at the grommet seating station. The grommet seating assembly includes a grommet press. The grommet press includes a support wall, a ram movably coupled to the support wall, and an actuator operably coupled to the ram to move the ram between an upper position and a lower position. The ram includes a grommet press tool having a press surface. The press surface is configured to engage and press the grommet into the housing when the ram is moved from the upper position to the lower position to seat the grommet in the housing at a seated position.

In another embodiment, a connector assembly machine for an electrical connector is provided. The connector assembly machine includes a feeder assembly that includes a feeder device configured to feed a carrier to a housing loading station, a grommet loading station, and a grommet seating station. The connector assembly machine includes a housing loading assembly at the housing loading station. The housing loading assembly is configured to load housings into corresponding cavities in the carrier. The connector assembly machine includes a grommet loading assembly at the grommet loading station. The grommet loading assembly is configured to load grommets into the housings to pre-seated positions. The connector assembly machine includes a grommet seating assembly at the grommet seating station. The grommet seating assembly includes a grommet press. The grommet press includes a grommet press tool having a press surface. The press surface is configured to engage and press the corresponding grommet into the housing to seat the grommet in the housing from the pre-seated position at a seated position.

In a further embodiment, a method of assembling an electrical connector is provided. The method feeds a carrier holding a plurality of housings and a corresponding plurality of grommets to a grommet seating station. At the grommet seating station, the method presses the grommets into the corresponding housings to seated positions using a grommet press movable relative to the carrier. The grommet press includes at least one press tool having at least one press surface configured to engage and press the grommets into the housings during actuation of the grommet press.

### BRIEF DESCRIPTION OF THE DRAWINGS

FIG. 1 is a schematic view of a connector assembly machine in accordance with an exemplary embodiment.

FIG. 2 is a front perspective view of the electrical connector in accordance with an exemplary embodiment.

FIG. 3 is a rear perspective view of the electrical connector in accordance with an exemplary embodiment.

FIG. 4 is a rear perspective view of the electrical connector partially assembled showing the grommet in the pre-seated position in the housing in accordance with an exemplary embodiment.

FIG. 5 is a perspective view of the grommet seating assembly in accordance with an exemplary embodiment.

FIG. 6 illustrates a method of assembling an electrical connector in accordance with an exemplary embodiment.

### DETAILED DESCRIPTION OF THE INVENTION

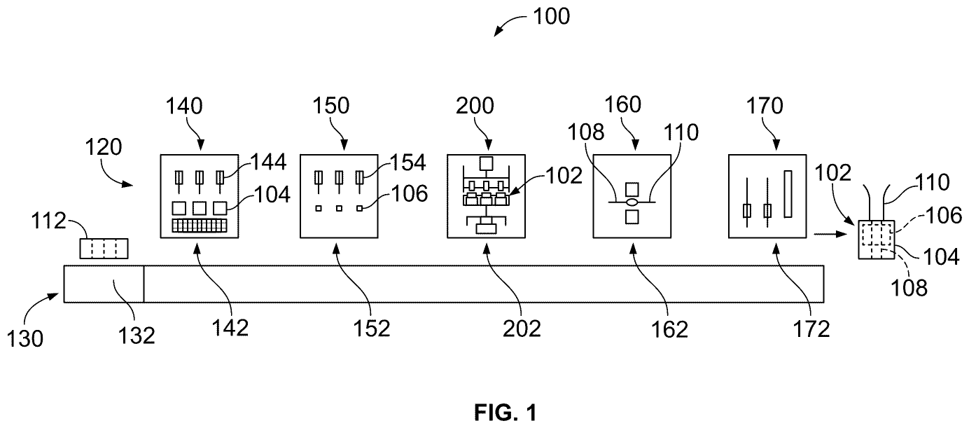

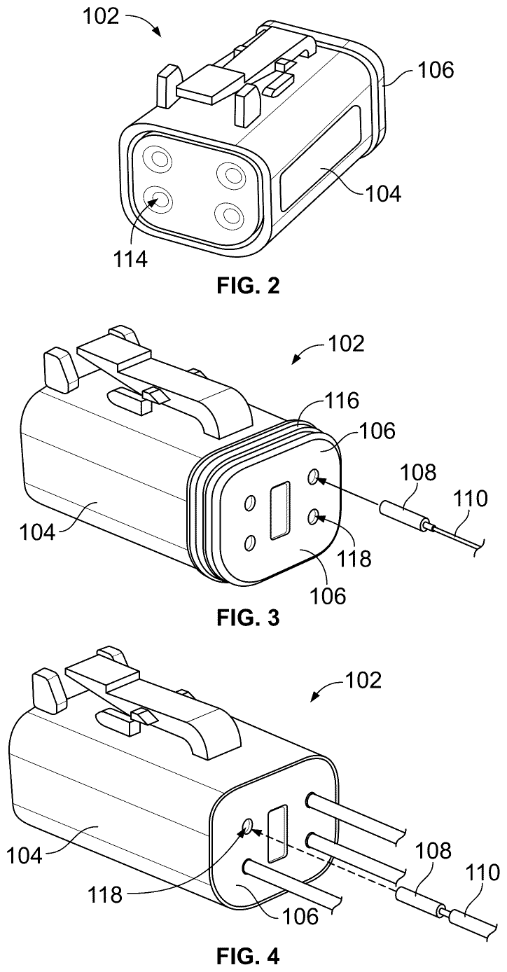

FIG. 1 is a schematic view of a connector assembly machine 100 in accordance with an exemplary embodiment. The connector assembly machine 100 is used to assemble an electrical connector 102 (shown in FIGS. 2 and 3). In an exemplary embodiment, the electrical connector 102 includes a housing 104 and a grommet 106 loaded into the housing 104. The housing 104 is configured to hold one or more contacts 108, which are terminated to ends of corresponding wires 110. The contacts 108 may be signal contacts, ground contacts, or power contacts.

In an exemplary embodiment, multiple electrical connectors 102 may be manufactured simultaneously. For example, the electrical connectors 102 may be manufactured in batches. In an exemplary embodiment, the connector assembly machine 100 utilizes carriers 112 used to carry components of the electrical connector 102 during the assembly process. For example, each carrier 112 may include multiple cavities that hold corresponding housings 104 the electrical connectors 102 may be assembled in series or in parallel during the assembly process. For example, the assembly steps may occur sequentially or in unison for the various electrical connectors 102.

In an exemplary embodiment, the grommet 106 provides a sealed interface to the housing 104 and/or the contacts 108 and/or the wires 110. For example, the grommet 106 may be provided at the rear of the housing 104 and include ports or openings therethrough that receive the contacts 108 and the wires 110. The grommet 106 is configured to be sealed to the housing 104 at the outer periphery of the grommet 106. The grommet 106 is configured to be sealed to the wires 110 at the ports where the wires 110 pass through the grommet 106. The grommet 106 may be a rubber grommet.

In an exemplary embodiment, the connector assembly machine 100 is used to install the grommet 106 in the housing 104 by an automated process. The connector assembly machine 100 is used to reduce assembly time, such as compared to manual or hand assembly of electrical connectors. The connector assembly machine 100 ensures reliable positioning of the components during assembly. For example, the connector assembly machine 100 insurers reliable positioning of the grommet 106 in the housing 104.

In an exemplary embodiment, the connector assembly machine 100 includes one or more stations 120 used for processing and/or assembly of the electrical connector 102. The stations 120 may be incorporated into a single machine. For example, the stations 120 may be incorporated into a single enclosure or cabinet and/or may be mounted to a common frame or base. In other various embodiments, the stations 120 may be arranged in an assembly line, such as being incorporated into multiple machines at different locations within an assembly facility.

In an exemplary embodiment, the connector assembly machine 100 includes a feeder assembly 130 used to feed the parts or components between the various stations 120. The feeder assembly 130 includes a feeder device 132 configured to feed departure components between the various stations 120. In various embodiments, the feeder device 132 may be a conveyor. In other various embodiments, the feeder device 132 may be a part handling robot, such as a robot including one or more articulated robot arms configured to pick and place the parts or components.

In an exemplary embodiment, the connector assembly machine 100 includes a housing loading assembly 140 at a housing loading station 142. The housing loading assembly 140 is configured to load the housings 104 into corresponding cavities in the carrier 112. In an exemplary embodiment, the housing loading assembly 140 includes one or more housing loading devices 144 used to load the housings 104 into the carrier 112. In alternative embodiments, the housings 104 may be initially loaded by hand into the carrier 112 rather than being automatically loaded using the housing loading assembly 140. For example, the connector assembly machine 100 may be provided without the housing loading assembly 140.

The housing loading devices 144 may be pick and place devices, such as articulated robot arms having grippers or vacuum suction elements at the end of the robot arm used to pick and place the housings 104. In other various embodiments, the housing loading devices 144 may be insertion devices having an insertion pin that is actuated to load the housings 104 into the cavities of the carrier 112. Other types of loading devices may be used to load the housings 104 into the carrier 112. Optionally, multiple housing loading devices 144 are provided to simultaneously load multiple housings 104 into the carrier 112. Alternatively, the housing loading assembly 140 may include a single housing loading device 144 that loads the housings 104 into the different cavities of the carrier 112 as the feeder assembly 130 moves the carrier 112 through the housing loading station 142.

In an exemplary embodiment, the connector assembly machine 100 includes a grommet loading assembly 150 at a grommet loading station 152. The grommet loading assembly 150 is configured to load the grommets 106 into cavities or chambers of the corresponding housings 104. For example, the grommets 106 may be loaded into the rear portions of the housings 104. In an exemplary embodiment, the grommet loading assembly 150 includes one or more grommet loading devices 154 used to initially load the grommets 106 into the housings 104. In an exemplary embodiment, the grommet loading devices 154 partially load the grommets 106 into the housings 104 to pre-seated positions. For example, the grommets 106 are only partially loaded into the housings 104 in the pre-seated positions. Portions of the grommets 106 may stand-proud of the housing 104 and extend rearward of the rear ends of the housings 104 in the preceded positions. In alternative embodiments, the grommets 106 may be initially assembled by hand to the pre-seated positions rather than being automatically loaded using the grommet loading assembly 150. For example, the connector assembly machine 100 may be provided without the grommet loading assembly 150.

The grommet loading devices 154 may be pick and place devices, such as articulated robot arms having grippers or vacuum suction elements at the end of the robot arm used to pick and place the grommets 106. In other various embodiments, the grommet loading devices 154 may be insertion devices having an insertion pin that is actuated to load the grommets 106 into the cavities of the carrier 112. Other types of loading devices may be used to load the grommets 106 into the carrier 112. Optionally, multiple grommet loading devices 154 are provided to simultaneously load multiple grommets 106 into the housings 104. Alternatively, the grommet loading assembly 150 may include a single grommet loading device 154 that loads the grommets 106 into the different cavities of the housings 104 as the feeder assembly 130 moves the carrier 112 through the grommet loading station 152.

In an exemplary embodiment, the connector assembly machine 100 includes a grommet seating assembly 200 at a grommet seating station 202. The grommet seating assembly 200 is used to press the grommets 106 into the corresponding housings 104 to fully assemble or seat the grommets 106 in the housings 104. For example, the grommet seating assembly 200 presses the grommets 106 into the housings 104 from the pre-seated positions (at the grommet loading assembly 150) to seated positions. In an exemplary embodiment, the grommets 106 are fully loaded into the housings 104 in the seated positions. For example, the rear ends of the grommets 106 may be flush with or recessed into the rear ends of the housings 104. The grommet seating assembly 200 ensures the proper positioning of the grommets 106 in the housings 104 in a reliable and repeatable manner. The grommet seating is performed automatically by the connector assembly machine 100 quickly, efficiently, precisely, and repeatedly. In an exemplary embodiment, the grommet seating assembly 200 is configured to press multiple grommets 106 into the corresponding housings 104 simultaneously at the grommet seating station 202 to reduce cycle time, which reduces overall assembly time and increases throughput through the connector assembly machine 100.

In an exemplary embodiment, the connector assembly machine 100 includes a contact termination assembly 160 at a contact termination station 162. The contact termination assembly 160 is configured to terminate the contacts 108 to the wires 110. For example, the contact termination assembly 160 may be configured to crimp, solder, weld, or otherwise terminate the contacts 108 to the ends of the wires 110. The contact termination assembly 160 may be a terminator device having a forming anvil and a crimp press configured to crimp the end of the contact 108 to the wire 110. In alternative embodiments, the contacts 108 may be hand terminated to the wires 110 rather than being automatically terminated using the contact termination assembly 160. For example, the connector assembly machine 100 may be provided without the contact termination assembly 160.

In an exemplary embodiment, the connector assembly machine 100 includes a contact loading assembly 170 at a contact loading station 172. The contact loading assembly 170 is configured to load the contacts 108 and the wires 110 into the ports or openings through the grommets 106. The contact loading assembly 170 is configured to load the contacts 108 into corresponding contact cavities in the housings 104, such as to complete assembly of the electrical connector 102. The contacts 108 may be rear loaded into the grommets 106 and pass through the grommets 106 into the contact cavities of the housings 104. The grommets 106 are configured to be sealed to the contacts 108 and/or the wires 110 when the contacts 108 and the wires 110 pass through the ports in the grommets 106. In an exemplary embodiment, the contact loading assembly 170 includes one or more contact loading devices 174 used to load the contacts 108 into the grommets 106. In alternative embodiments, the contacts may be hand loaded into the grommets 106 rather than being automatically loaded by the contact loading devices 174. For example, the connector assembly machine 100 may be provided without the contact loading assembly 170.

FIG. 2 is a front perspective view of the electrical connector 102 in accordance with an exemplary embodiment. FIG. 3 is a rear perspective view of the electrical connector 102 in accordance with an exemplary embodiment. FIG. 4 is a rear perspective view of the electrical connector 102 partially assembled showing the grommet 106 in the pre-seated position in the housing 104 (for example, prior to assembly by the grommet seating assembly 200).

In an exemplary embodiment, the electrical connector 102 includes the housing 104 and the grommet 106 loaded into the housing 104. The housing 104 includes contact channels 114 holding the contacts 108. In the illustrated embodiment, the electrical connector 102 is shown as a four-position connector including four of the contacts 108 (such as in a 2×2 arrangement). The electrical connector 102 may include greater or fewer contacts 108 in alternative embodiments. The contacts 108 may be arranged in other arrangements (for example, different number of rows and/or columns of the contacts 108) in alternative embodiments. The contacts 108 may be signal contacts, ground contacts, or power contacts. The wires 110 extend from the rear of the electrical connector 102.

In an exemplary embodiment, the grommet 106 is configured to be sealed to the housing 104. For example, the grommet 106 includes a peripheral seal 116 around an outer periphery of the grommet 106. The grommet 106 may be sized and shaped to match an interior surface of the rear cavity of the housing 104 to seal to the interior surface of the housing 104. The peripheral seal 116 is configured to interface with the housing 104 when the grommet 106 is loaded to the seated position (FIG. 3). In an exemplary embodiment, the grommet 106 is configured to be sealed to the contacts 108 and/or the wires 110 passing through ports 118 in the grommet 106. The grommet 106 may be manufactured from a rubber material or other suitable material configured to be sealed to the housing 104 and the wires 110.

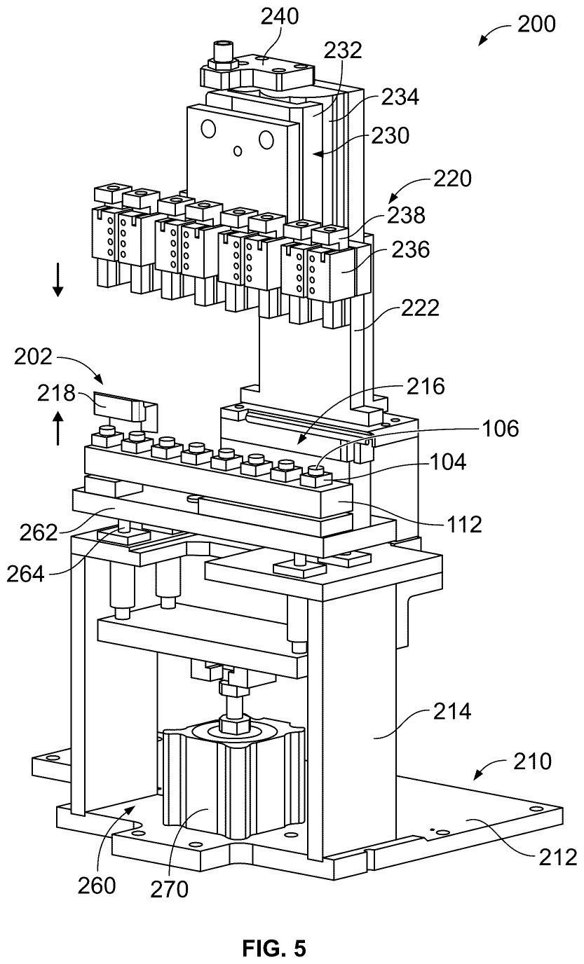

FIG. 5 is a perspective view of the grommet seating assembly 200 in accordance with an exemplary embodiment. The grommet seating assembly 200 is used to press the grommets 106 into the corresponding housings 104 to fully assemble or seat the grommets 106 in the housings 104. For example, the grommet seating assembly 200 presses the grommets 106 into the housings 104 from pre-seated positions to seated positions. The grommet seating assembly 200 ensures the proper positioning of the grommets 106 in the housings 104 in a reliable and repeatable manner. The grommet seating is performed automatically by the grommet seating assembly 200 quickly, efficiently, precisely, and repeatedly. In an exemplary embodiment, the grommet seating assembly 200 is configured to press multiple grommets 106 into the corresponding housings 104 simultaneously at the grommet seating station 202 to reduce cycle time, which reduces overall assembly time and increases throughput through the connector assembly machine 100.

The grommet seating assembly 200 includes a frame 210 supporting the components of the grommet seating assembly 200. In an exemplary embodiment, the grommet seating assembly 200 includes a grommet press 220 mounted to the frame 210. The grommet press 220 is configured to press the grommets 106 into the housings 104. In an exemplary embodiment, the grommet seating assembly 200 includes a carrier lifter 260 mounted to the frame 210. The carrier lifter 260 is configured to lift the carrier 112 toward the grommet press 220. However, in alternative embodiments, the grommet seating assembly 200 may be provided without the carrier lifter 260. For example, the carrier 112 may be held at a stationary position in the grommet seating assembly 200 rather than being lifted or moved toward the grommet press 220.

The frame 210 includes a plurality of walls or panels used to support the components of the grommet seating assembly 200. In an exemplary embodiment, the frame 210 includes a base 212 at a bottom of the grommet seating assembly 200. The frame 210 includes support walls 214 extending from the base 212. The frame 210 may include other walls or support elements.

In an exemplary embodiment, the grommet seating assembly 200 includes a loading zone 216. The loading zone 216 may be located above the base 212. The loading zone 216 may be at an elevated position above the base 212. The carrier 112 is configured to be positioned in the loading zone 216. For example, the feeder assembly 130 (shown in FIG. 1) is configured to transfer the carrier 112 to the loading zone 216, such as for processing by the grommet press 220. The loading zone 216 may be aligned with the grommet press 220. The grommet press 220 may be movable in the loading zone 216 to interface with the grommets 106, such as to press the grommets 106 to the seated positions.

In an exemplary embodiment, the grommet seating assembly 200 includes a position sensor 218 at the loading zone 216. The position sensor 218 is configured to sense a position of the carrier 112 in the loading zone 216. The position sensor 218 may be a proximity sensor, an RFID sensor, a photosensor, a capacitive sensor, a mechanical switch, or another type of sensor configured to detect the presence or position of the carrier 112. In an exemplary embodiment, the grommet press 220 may be operated based on input (for example, signals) from the position sensor 218. The carrier lifter 260 may be operated based on input from the position sensor.

In an exemplary embodiment, the grommet press 220 includes a support wall 222, a ram 230 movably coupled to the support wall 222, and an actuator 240 operably coupled to the ram 230. During use, the ram 230 is moved to press the grommets 106 into the housings 104. In an exemplary embodiment, the ram 230 is slidably coupled to the support wall 222 to move in a linear sliding direction. For example, the ram 230 is movable along a vertical axis. The ram 230 is movable between an upper position and a lower position. The actuator 240 is operated to move the ram 230 between the upper position and the lower position. The actuator 240 may be a pneumatic actuator, an electric actuator, or another type of actuator. The actuator 240 may be operated based on input signals from the position sensor 218. For example, when the position sensor 218 detects that the carrier 112 is in position on the platform 262, the actuator 240 may be operated to press the ram 230 downward for seating of the grommets 106 by the grommet press 220.

In an exemplary embodiment, the ram 230 includes a slide 232 and a guide track 234. The guide track 234 is mounted to the support wall 222. The slide is slidably coupled to the guide track 234 and is movable along the guide track 234 between the upper position and the lower position. Other types of movement control elements may be provided to allow and guide the movement of the ram 230.

In an exemplary embodiment, the ram 230 includes a tool holder 236 and one or more grommet press tools 238 coupled to the tool holder 236. The grommet press tools 238 are configured to seat the grommets 106 in the corresponding housings 104 at the seated positions. The grommet press tools 238 are movable with the ram 230, such as being movable when the ram 230 is moved from the upper position to the lower position. In various embodiments, the tool holder 236 includes multiple grommet press tools 238, such as one associated with each of the grommets 106.

In the illustrated embodiment, the tool holder 236 holds eight grommet press tools 238 arranged in a row. Greater or fewer grommet press tools 238 may be provided in alternative embodiments. In an exemplary embodiment, the press surfaces of the grommet press tools 238 may be aligned along a common press plane. The press plane may be oriented horizontally. The press surfaces are configured to interface with the grommets 106 at the press plane such that each of the grommets 106 are configured to be pressed into the housings 104 to the same depth. The grommet press tools 238 may be arranged in multiple rows (for example, staggered) in other various embodiments. Each grommet press tool 238 includes a press surface configured to engage and press the corresponding grommet(s) 106 into the corresponding housing(s) 104. The grommet press tools 238 may be movable together as a unit to interface with multiple grommets 106 simultaneously. As such, the pressing actions for the grommets 106 may occur with a single action by the grommet press 220 to decrease cycle time and increase throughput. In other various embodiments, the grommet press tools 238 may include multiple press surfaces. For example, each grommet press tool 238 may be configured to interface with multiple grommets 106.

In an exemplary embodiment, the grommet press tools 238 may be adjustable, such as to mate with different types of grommets 106, such as different size or thickness grommets 106. In various embodiments, the tool holder 236 may hold different types of grommet press tools 238 at the various positions. The different types of grommet press tools 238 are configured to interface with different types (for example, different size and/or different shape) grommets 106 configured to be pressed into different types (for example, different size and/or different shape) housings 104 configured to be held by the carrier 112.

In an exemplary embodiment, the carrier lifter 260 includes a platform 262 configured to support the carrier 112 and an actuator 270 operably coupled to the platform 262. The actuator 270 is configured to lift the platform 262 from a lower position to an upper position to move the carrier 112 toward the grommet press tools 238. In an exemplary embodiment, the platform 262 is slidably coupled to the frame 210, such as to one of the support walls 214. For example, lifter arms 264 may be slidably coupled to the support walls 214 to move the platform 262 relative to the frame 210, such as along a vertical axis. The actuator 270 is operated to move the platform 262 between the upper position and the lower position. The actuator 270 may be a pneumatic actuator, an electric actuator, or another type of actuator. The actuator 270 may be coupled to the frame 210, such as to the base 212. The actuator 270 may be operated based on input signals from the position sensor 218. For example, when the position sensor 218 detects that the carrier 112 is in position on the platform 262, the actuator 270 may e operated to lift the platform 262, and thus the carrier 112, into position in the loading zone 216 for seating of the grommets 106 by the grommet press 220.

After the pressing operation, the grommet press 220 may return to the nominal or upper position to release from the grommets 106. The carrier lifter 260 may return to the nominal or lower position to release the carrier 112. The carrier 112 is then able to be removed from the loading zone 216 by the feeder assembly 130. For example, the carrier 112 may be transferred to the next processing station. Once the carrier 112 is removed from the loading zone 216, another carrier 112 may be moved into the loading zone by the feeder assembly 130 for processing.

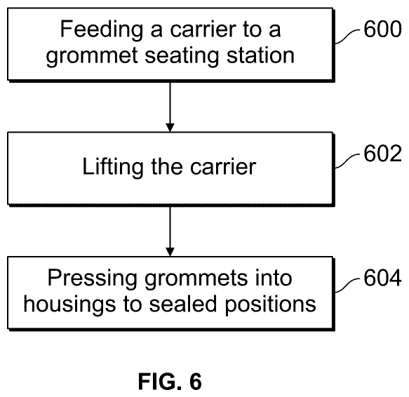

FIG. 6 illustrates a method of assembling an electrical connector in accordance with an exemplary embodiment.

At 600, the method includes feeding a carrier holding a plurality of housings and a corresponding plurality of grommets to a grommet seating station. The carrier may be feed to the grommet seating station by a feeder assembly, such as a conveyor, an articulating robot arm, or other type of feeder device.

Optionally, the method may include detecting presence or a position of the carrier in the grommet seating station. For example, a position sensor may be provided to detect the position of the carrier. Other processing steps may be performed based on signals from the position sensor.

At 602, the method includes lifting the carrier in an upward lifting direction to move the carrier toward the grommet press tool. The carrier may be lifted upward to properly position the carrier at a predetermined position in the grommet seating station. For example, the carrier may be positioned at a predetermined vertical height to locate the housings at a certain height relative to a grommet press device to ensure proper seating of the grommets in the housings.

At 604, the method includes pressing the grommets into the corresponding housings to seated positions. The pressing operation may be performed by a grommet press that is movable relative to the carrier. The grommet press may include at least one press tool having at least one press surface configured to engage and press the grommets into the housings during actuation of the grommet press. the grommet press presses the grommets into the housings from pre-seated positions to seated positions. The grommet press ensures the proper positioning of the grommets in the housings in a reliable and repeatable manner. The grommet seating is performed automatically by the grommet press quickly, efficiently, precisely, and repeatedly. In an exemplary embodiment, the grommet press is configured to press multiple grommets into the corresponding housings simultaneously at the grommet seating station to reduce cycle time, which reduces overall assembly time and increases throughput through the connector assembly machine.

Optionally, the pressing operation may include the step of actuating a ram in a vertical pressing direction between an upper position and a lower position to move the at least one press tool into engagement with the corresponding grommet. The pressing operation may include the step of simultaneously pressing all of the grommets into the corresponding housings.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. A connector assembly machine for an electrical connector including a grommet in a housing, the connector assembly machine comprising:
a feeder assembly including a feeder device configured to feed a carrier holding the housing and the grommet to a grommet seating station;
a grommet seating assembly at the grommet seating station, the grommet seating assembly including a grommet press, the grommet press including a support wall, a ram movably coupled to the support wall, and an actuator operably coupled to the ram to move the ram between an upper position and a lower position, the ram including a grommet press tool having a press surface, the press surface configured to engage and press the grommet into the housing when the ram is moved from the upper position to the lower position to seat the grommet in the housing at a seated position.

2. The connector assembly machine of claim 1, wherein the ram moves in a vertical pressing direction between the upper position and the lower position.

3. The connector assembly machine of claim 1, wherein the grommet press includes a guide track between the ram and the support wall to guide movement of the ram between the upper position and the lower position.

4. The connector assembly machine of claim 1, wherein the grommet seating assembly includes a position sensor at the grommet seating station configured to sense a position of the carrier, the actuator being operated based on input from the position sensor.

5. The connector assembly machine of claim 1, wherein the grommet press tool is a first grommet press tool, the ram including a second grommet press tool having a second press surface.

6. The connector assembly machine of claim 5, wherein the first grommet press tool and the second grommet press tool are movable simultaneously with the ram to press corresponding grommets into the corresponding housings.

7. The connector assembly machine of claim 5, wherein the first grommet press tool is configured to press a first size grommet into a first size housing and the second grommet press tool is configured to press a second size grommet into a second size housing different from the first size grommet.

8. The connector assembly machine of claim 1, wherein the grommet press tool is one of a plurality of grommet press tools for simultaneously pressing multiple grommets into corresponding housings.

9. The connector assembly machine of claim 8, wherein each of the grommet press tools have corresponding press surfaces aligned along a press plane configured to press the grommets to common depths within the corresponding housings.

10. The connector assembly machine of claim 8, wherein the ram includes a tool holder holding the plurality of the grommet press tools relative to the ram.

11. The connector assembly machine of claim 1, wherein the grommet seating assembly further comprises a carrier lifter having a platform configured to support the carrier and an actuator operably coupled to the platform to lift the platform from a lower position to an upper position to move the carrier toward the grommet press tool.

12. The connector assembly machine of claim 11, wherein the grommet seating assembly includes a position sensor configured to sense a position of the carrier, the carrier lifter operated based on input from the position sensor.

13. The connector assembly machine of claim 1, wherein the feeder includes one of a conveyor or a robot arm configured to move the carrier.

14. A connector assembly machine for an electrical connector, the connector assembly machine comprising:
a feeder assembly including a feeder device configured to feed a carrier to a housing loading station, a grommet loading station, and a grommet seating station;
a housing loading assembly at the housing loading station, the housing loading assembly configured to load housings into corresponding cavities in the carrier;
a grommet loading assembly at the grommet loading station, the grommet loading assembly configured to load grommets into the housings to pre-seated positions; and
a grommet seating assembly at the grommet seating station, the grommet seating assembly including a grommet press, the grommet press including a grommet press tool having a press surface, the press surface configured to engage and press the corresponding grommet into the housing to seat the grommet in the housing from the pre-seated position at a seated position.

15. The connector assembly machine of claim 14, wherein the grommet press includes a support wall, a ram movably coupled to the support wall, and an actuator operably coupled to the ram to move the ram between an upper position and a lower position, the ram holding the grommet press tool, the grommet press configured to engage and press the grommet into the housing when the ram is moved from the upper position to the lower position to seat the grommet in the housing at the seated position
16. The connector assembly machine of claim 14, wherein the grommet seating assembly further comprises a carrier lifter having a platform configured to support the carrier and an actuator operably coupled to the platform to lift the platform from a lower position to an upper position to move the carrier toward the grommet press tool.

17. A method of assembling an electrical connector comprising:
feeding a carrier holding a plurality of housings and a corresponding plurality of grommets to a grommet seating station;
at the grommet seating station, pressing the grommets into the corresponding housings to seated positions using a grommet press movable relative to the carrier, the grommet press including at least one press tool having at least one press surface configured to engage and press the grommets into the housings during actuation of the grommet press.

18. The method of claim 17, wherein said pressing the grommets into the corresponding housings includes actuating a ram in a vertical pressing direction between an upper position and a lower position to move the at least one press tool into engagement with the corresponding grommet.

19. The method of claim 17, wherein said pressing the grommets into the corresponding housings includes simultaneously pressing all of the grommets into the corresponding housings.

20. The method of claim 17, further comprising lifting the carrier in an upward lifting direction to move the carrier toward the grommet press tool.
